(19) United States
(12) Patent Application Publication
(10) Pub. No.: US 2009/0004324 A1
(43) Pub. Date: Jan. 1, 2009

(54) DEVICE FOR INJECTION MOLDING A TUBULAR ELEMENT FROM SYNTHETIC MATERIAL

(76) Inventors: DANIEL VIEL, ARBENT (FR); JEAN-YVES LAFOURCADE, TECAMACHALCO (MX)

Correspondence Address: CANTOR COLBURN, LLP, 20 Church Street, 22nd Floor, Hartford, CT, 06103, US

(21) Appl. No.: 12/130,025

(22) Filed: May 30, 2008

Related U.S. Application Data
(60) Provisional application No. 60/953,358, filed on Aug. 1, 2007.

(30) Foreign Application Priority Data
May 31, 2007 (FR) 0703864

(51) Int. Cl. B29C 45/56

(52) U.S. Cl. 425/577

(57) ABSTRACT

The invention relates to a device for injection molding a tubular element from synthetic material, particularly a tube for dispensing pasty product, comprising an outer mold intended to define the external wall of the tubular element, a main insert which, intended to define the internal wall of the tubular element, extends along the axis of the tubular element, the main insert being fixedly connected to the outer mold at a first end during the molding operation and being movable with respect to the outer mold during a demolding operation.

### BACKGROUND OF THE INVENTION

The invention relates to a device for injection molding a tubular element from, synthetic material, particularly a tube for dispensing pasty product.

### DESCRIPTION OF THE PRIOR ART

A conventional molding device is known from document EP 0 040 615. As described with reference to FIG. 1, this device comprises an outer mold 1 intended to define the external wall of the tubular element.

This known molding device also comprises a main insert 2 which, intended to define the internal wall of the tubular element, extends along the axis A of the tubular element, the main insert 2 being fixedly connected to the outer mold 1 at a first end 4 during a molding operation and being movable with respect to the outer mold 1 during a demolding operation.

This type of molding device has the disadvantages explained hereinbelow.

Synthetic material is conveyed to the outer mold via a duct 5 centered on the axis A of the tubular element. The tubular element additionally comprises a pasty material delivery opening which, because the material is injected along the axis of the tube, has to be offset from this axis.

It is therefore not possible to produce an opening which is centered with respect to the tube.

Furthermore, the main insert is connected to the outer mold at just one end. Synthetic material is injected into the outer mold at very high pressures of the order of 1500 to 2500 bar. The injection of material therefore exerts strong forces on the main insert, causing the latter to bend and as a result of this being that the free end of the main insert moves closer to the wall of the outer mold.

The tubular element thus molded may have a wall of non-uniform wall thickness, or may even exhibit regions where there is no material.

It is therefore necessary to design in a significant excess of thickness, particularly at the end of the tube facing the injection side, so as to compensate for the phenomena of insert bending and avoid regions where material is absent. Such excesses of thickness lead to significant additional costs and are unable to guarantee uniform wall thickness for the tubular element.

In addition, once the synthetic material has cooled, a lump of material projects outwards from the end wall of the tubular element at the point of injection. It is therefore necessary to trim off the excess material after molding.

### SUMMARY OF THE INVENTION

The invention aims to solve these disadvantages by proposing a molding device that makes it possible to obtain tubular elements the walls of which have a substantially constant wall thickness, in which the position of the opening can be chosen to lie at any point, and which do not have excess material projecting outwards.

To this end, the invention relates to a molding device of the aforementioned type wherein the main insert has a housing opening towards the outside at its opposite end to the end that is connected to the outer mold, the molding device further comprising a secondary insert of an overall shape that complements that of the housing of the main insert and which, inserted in the housing in the molding position has a synthetic material inlet duct and at least one peripheral groove intended to allow the synthetic material to flow from the inlet duct to the volume defined by the outer mold and the main insert.

The synthetic material is injected via the inlet duct of the secondary insert, the latter also holding the main insert in position so as to prevent it from bending.

The synthetic material passes in succession along the inlet duct and around the peripheral groove of the secondary inset before filling the volume defined by the main insert and the outer mold.

After cooling, demolding can be performed in a way known per se by withdrawing the main insert.

The tubular element thus obtained comprises, thanks to the fact that the main insert is held in position, a wall of constant wall thickness. A pasty product delivery opening is delimited by the lateral wall of the secondary insert, The tubular element further comprises a part projecting towards the inside of the tube, corresponding to the excess synthetic material contained by the inlet duct and the peripheral groove.

The device according to the invention also makes it possible to produce tubes of different diameters and lengths at higher speed.

Advantageously, the housing extends along the axis of the main insert.

The outer mold, the main insert and the secondary insert are therefore centered about the same axis, so as to ensure good distribution of the pressures exerted on the main insert.

According to one feature of the invention, the housing of the main insert is of frustoconical shape, widening towards its open end.

The frustoconical shape of the housing and, therefore, of the secondary insert that has a complementary shape, makes it easier to center the main insert while at the same time allow for demolding.

As a preference, the secondary insert is mounted on a synthetic material injection head, for example by screwing.

According to one possibility of the invention, the synthetic material inlet duct is of frustoconical overall shape, the inlet duct widening towards its end facing towards the main insert.

The frustoconical shape thus forms a relief angle facilitating demolding.

Advantageously, the inlet duct extends along the axis of the secondary insert.

As a preference, the secondary insert comprises at least three peripheral grooves.

According to one feature of the invention, the length of the frustoconical housing is greater than the length of the secondary insert so that, in the molding position, a chamber is formed, the purpose of this chamber being to accommodate synthetic material between the secondary insert and the closed end of the housing of the main insert.

The volume of material thus formed can be used to compensate for the shrinkage of the material as it cools. It also forms a buffer volume to balance the material removal pressures in the peripheral grooves.

### BRIEF DESCRIPTION OF THE DRAWINGS

In any event, the invention will be clearly understood with the aid of the description which follows, with reference to the attached diagrammatic drawing which, by way of nonlimiting example, depicts one embodiment of this molding device.

FIG. 1 is a view in longitudinal section of a molding device of the prior art;

FIG. 2 is a view corresponding to FIG. 1 of a molding device according to the invention, in the molding position;

FIG. 3 is an enlarged view of the secondary insert of FIG. 2;

FIG. 4 is a perspective view, from above, of the tubular element after molding;

FIG. 5 is a view in longitudinal section of the tubular element on the line B of FIG. 4.

### DESCRIPTION OF THE PREFERRED EMBODIMENT

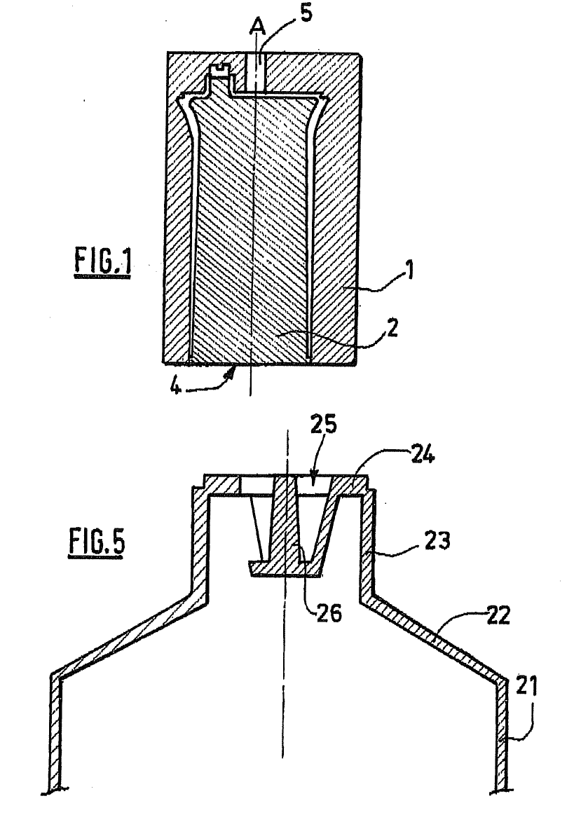

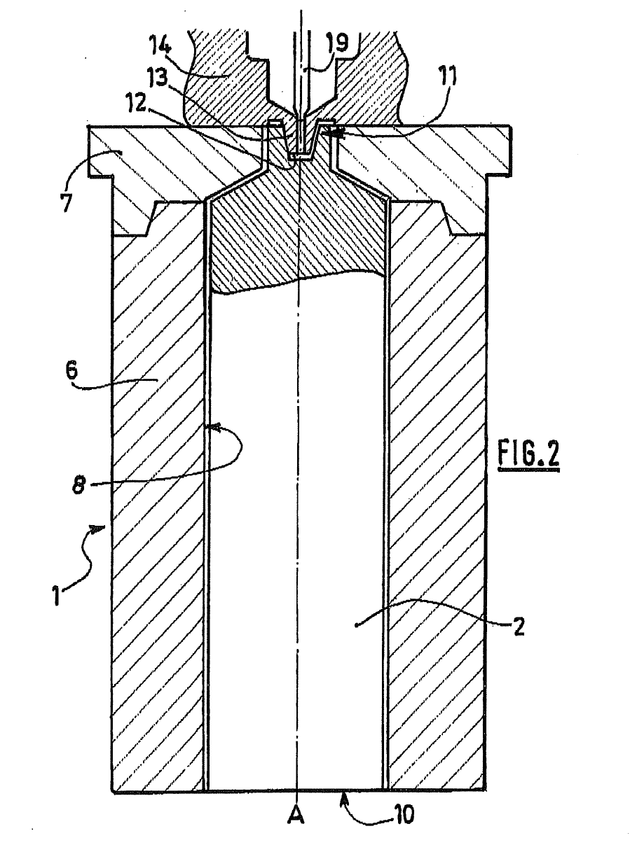

The molding device according to the invention is depicted in FIG. 2. The elements that correspond to those of the device of the prior art depicted in FIG. 1 are denoted by the same references.

The molding device according to the invention comprises an outer mold 1 formed of several parts 6, 7 assembled fixedly with respect to one another by known means.

The internal wall 8 of the outer mold 1 is intended to define the external wall of a tubular element 9. The axis of the outer mold A will be defined as being the axis of the tubular element 9 after molding.

The molding device further comprises a main insert 2 which, intended to define the internal wall of the tubular element 9, extends inside the outer mold along the axis A thereof, between a first end 10 and a second end 11.

The main insert 2 is, during the molding operation, fixedly connected to the outer mold 1 at its first end 10.

The main insert 2 may be withdrawn from the outer mold 1, during the operation of demolding the tubular element 9.

The main insert 2 has a housing 12 opening to the outside at its second end 11, the housing 12 being of frustoconical shape, widening towards the second end 11.

As is more particularly apparent from FIG. 2, the molding device further comprises a secondary insert 13 extending along the axis of the outer mold 1 and of the main insert 2 between a first end 14 fixedly connected to the outer mold 1 by means of a support 5 and fixing screws, and a free second end 16.

The secondary insert 13 is of frustoconical overall shape, complementing that of the housing 12 of the main insert, and is inserted into the latter in the molding position.

The length of the frustoconical housing 12 is greater than the length of the secondary insert 13 so that a chamber 17 is formed in the molding position, the purpose of this chamber being to accommodate synthetic material between the secondary insert 13 and the closed end of the housing 12 of the main insert 2, as described hereinafter.

The secondary insert 13 has a synthetic material inlet duct 18 centered on the axis A of the secondary insert. The duct is of frustoconical shape, widening towards the free end 16 of the secondary insert 13.

The inlet duct 18 is connected to a synthetic material injection head or nozzle 19 which is fixed with respect to the secondary insert 13 and with respect to the outer mold 1.

The secondary insert 13 further comprises three peripheral grooves 20 uniformly spaced on its external wall, defining ducts for the circulation of material from the chamber 17 towards the volume defined by the outer mold 1 and the main insert 2.

The method of molding the tubular element 9 will be described hereinafter.

As the synthetic material is injected, it passes first of all along the inlet duct 18 then enters the chamber 17. The material then passes through the peripheral grooves 20 and fills the volume contained between the main insert 2 and the outer mold 1.

The injection pressure ranges between 1500 and 2200 bar, the temperature of the injected synthetic material being of the order of 320° C.

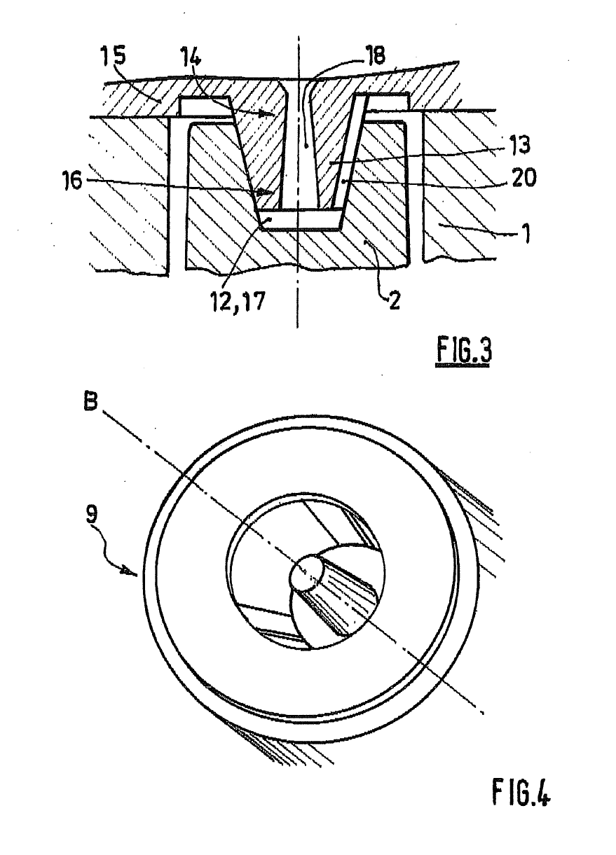

After cooling, the solidified synthetic material forms the tubular element 9 depicted in FIGS. 4 and 5, this element comprising a cylindrical body 21, a frustoconical region 22, a neck 23, an end wall 24, a central opening 25 and sprue 26 formed by the solidified material contained in the chamber 17 and the peripheral grooves 20.

Of course, the shape of the tubular element 9 may differ and is dependent on the shape of the outer mold 1 and of the main insert 2.

In order to demold, the main insert 2 is withdrawn from the outer mold 1, so as to release the tubular element 9.

It is thus possible to produce tubular elements 9 of different heights and diameters. The diameter of the tubular element will generally range between 15 and 100 mm, its maximum height being of the order of 250 mm.

The sprue 26 formed by the excess of synthetic material may or may not be detached from the end wall 24. Given that this sprue 26 extends inside the tubular element 9, not removing it generally has no impact on the use to which the tubular element 9 will be put.

In a way known per se, a service cap, not depicted, may be fixed or welded to the neck 23 of the tubular element 9.

As goes without saying, the invention is not restricted merely to the one embodiment of this system that has been described hereinabove by way of example but on the contrary encompasses all variants thereof. Thus, in particular, the number of peripheral grooves may be modified or the length of the secondary insert may be equal to that of the housing of the main insert.

1. A device for injection molding a tubular element from synthetic material, particularly a tube for dispensing pasty product, comprising an outer mold intended to define the external wall of the tubular element, a main insert which, intended to define the internal wall of the tubular element, extends along the axis of the tubular element, the main insert being fixedly connected to the outer mold at a first end during the molding operation and being movable with respect to the outer mold during a demolding operation, wherein the main insert has a housing opening towards the outside at its opposite end to the end that is connected to the outer mold, the molding device further comprising a secondary insert of an overall shape that complements that of the housing of the main insert and which, inserted in the housing in the molding position has a synthetic material inlet duct and at least one peripheral groove intended to allow the synthetic material to flow from the inlet duct to the volume defined by the outer mold and the main insert.

2. The device as claimed in claim 1, wherein the housing extends along the axis of the main insert.

3. The device as claimed in one of claims 1 and 2, wherein the housing of the main insert is of frustoconical shape, widening towards its open end.

4. The device as claimed in one of claims 1 to 3, wherein the secondary insert is mounted on a synthetic material injection head, for example by screwing.

5. The device as claimed in one of claims 1 to 4, wherein the synthetic material inlet duct is of frustoconical overall shape, the inlet duct widening towards its end facing towards the main insert.

6. The molding device as claimed in one of claims 1 to 5, wherein the inlet duct extends along the axis of the secondary insert.

7. The molding device as claimed in one of claims 1 to 6, wherein the secondary insert comprises at least three peripheral grooves.

8. The device as claimed in one of claims 1 to 7, wherein the length of the frustoconical housing is greater than the length of the secondary insert so that, in the molding position, a chamber is formed, the purpose of this chamber being to accommodate synthetic material between the secondary insert and the closed end of the housing of the main insert.
